(19) United States
(12) Patent Application Publication
(10) Pub. No.: US 2015/0046772 A1
(43) Pub. Date: Feb. 12, 2015

(54) METHOD AND DEVICE FOR ERROR CORRECTING CODE (ECC) ERROR HANDLING

(71) Applicant: Sandisk Technologies Inc., Plano, TX (US)

(72) Inventors: ALAN DAVID BENNETT, EDINBURGH (GB); THOMAS HUGH SHIPPEY, EDINBURGH (GB)

(73) Assignee: Sandisk Technologies Inc., Plano, TX (US)

(21) Appl. No.: 13/960,527

(22) Filed: Aug. 6, 2013

(51) Int. Cl. G06F 11/10; G06F 11/07

(52) U.S. Cl. CPC G06F 11/1016; G06F 11/0787
USPC 714/768

(57) ABSTRACT

A data storage device includes a non-volatile memory and a controller. A method includes determining a decoding error associated with information stored at a page of a first block of the non-volatile memory. In response to the decoding error, a physical address is accessed from the management table. The physical address corresponds to a trial logical address. In response to the physical address corresponding to the page, the method further includes moving data from the page to a second block of the non-volatile memory.

### FIELD OF THE DISCLOSURE

The present disclosure is generally related to data storage devices and more particularly to error correcting code (ECC) error handling for data storage devices.

### BACKGROUND

Non-volatile data storage devices, such as embedded memory devices and removable memory devices, have enabled increased portability of data and software applications. For example, flash memory devices may store multiple bits in each flash memory cell, enhancing data storage density. Data stored at such devices may be encoded using error correcting coding (ECC) techniques that protect the data from errors associated with power supply noise, temperature variations, and other causes of data corruption. ECC techniques are particularly useful as the number of bits stored per cell increases. Stored data may nonetheless be corrupted such that conventional ECC techniques are unable to recover the original data, potentially leading to lost or unrecoverable user data.

### SUMMARY

Techniques are disclosed that enable recovery of information when an error correcting code (ECC) codeword cannot be decoded. To illustrate, a controller of a data storage device may move data from a source compaction block to a destination compaction block (e.g., to consolidate data associated with a particular file into a single block during a compaction process). When moving the data, the controller typically accesses a logical address associated with the data to update a physical address of the data in a management table, such as a group address table (GAT). The management table may indicate that the logical address associated with the data corresponds to a first physical address associated with the source compaction block. In response to moving the data, the controller may update the management table to indicate that the data has been moved to the destination compaction block (i.e., that the logical address is associated with the second physical address).

If the source compaction block stores uncorrectable information, such as a header associated with an uncorrectable error correcting code (UECC) error, determining the logical address associated with the data may be difficult. If the logical address cannot be recovered, the controller may be unable to update the management table with the second physical address (since the management table may be indexed by logical addresses instead of physical addresses). When the management table is large (e.g., contains tens of thousands of entries), “crawling” through the management table to locate the first physical address may be laborious and time-consuming. Further, in at least some configurations, the controller is unable to move the data from the source compaction block to the destination compaction block without updating the management table, since such a technique may result in the logical address mapping to an incorrect physical address in the management table (e.g., the first physical address). Accordingly, the compaction process may stall in response to the UECC error unless the logical address can be recovered.

In accordance with at least one embodiment of the present disclosure, the controller determines one or more trial logical addresses using one or more remedial techniques. For example, if a first page of the source compaction block stores the information associated with the UECC error, the controller may access a second page that neighbors the first page (e.g., is adjacent to the first page) to search for the logical address, since the first page and the second page may store data that is included in a common file that is associated with related (e.g., adjacent) logical addresses. As another example, the controller may attempt to utilize the header “as is” despite the UECC error, since a portion of the header may be uncorrectable but another portion containing the logical address may be error-free. As another example, the controller may attempt to toggle bits of the header in case a single bit error prevents the header from being decoded. The one or more trial logical addresses may be confirmed or disconfirmed using the management table. For example, after determining the one or more trial logical addresses, the controller may access the management table using the one or more trial logical addresses to determine whether the management table maps any of the one or more trial logical addresses to the first physical address.

In at least one embodiment, if the controller determines that the logical address cannot be recovered remedially, the controller adds an indication of the first page of the source compaction block to a list of pages associated with decoding errors (e.g., UECC errors). If a host device attempts to read data from the first page, the controller may access the list of pages and indicate to the host device that the data cannot be read (e.g., by returning a predetermined data sequence to the host device). If the host device subsequently rewrites the data, then the first page may be erased (or overwritten) and the indication may be removed from the list of pages.

### BRIEF DESCRIPTION OF THE DRAWINGS

FIG. 1 is a block diagram of a particular illustrative embodiment of a system including a data storage device for error correcting code (ECC) error handling at a first time of operation;

FIG. 2 is a block diagram illustrating a particular configuration of the system of FIG. 1 at a second time of operation;

FIG. 3 is a flow chart of a particular illustrative embodiment of an example method of operation of the data storage device of FIG. 1; and

FIG. 4 is a flow chart of a particular illustrative embodiment of another example method of operation of the data storage device of FIG. 1.

### DETAILED DESCRIPTION

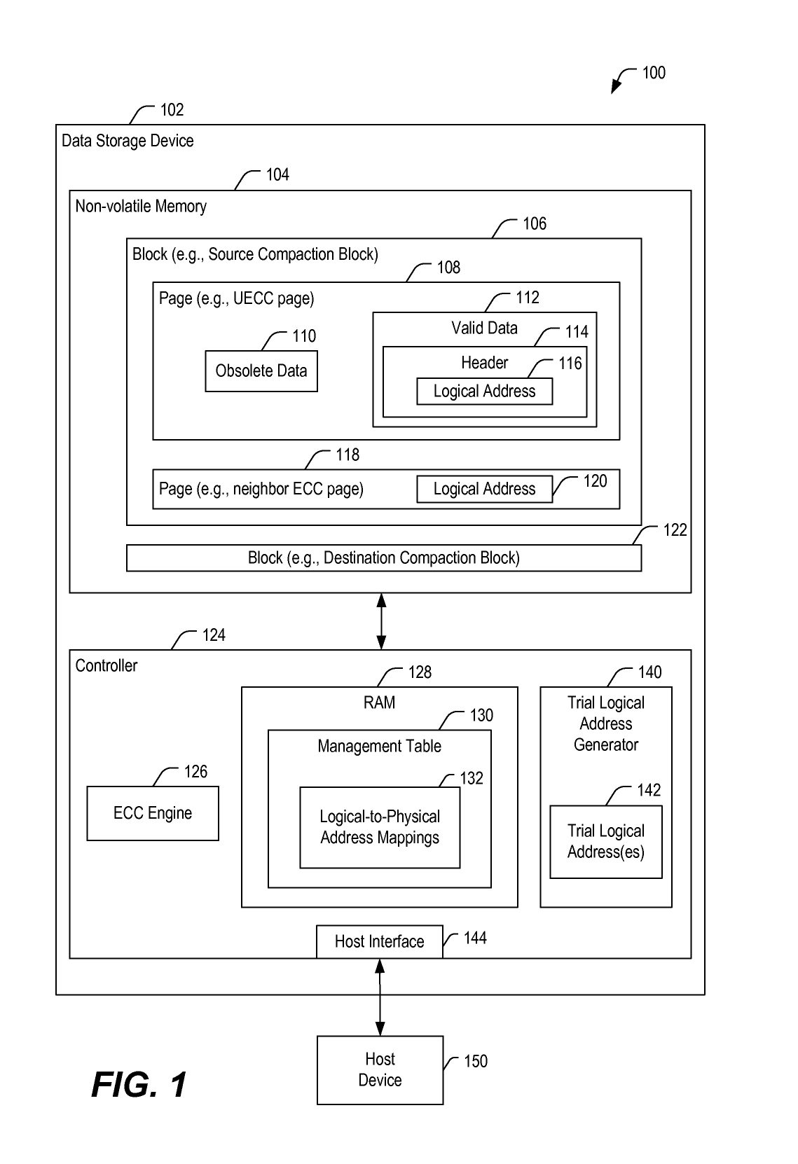

Referring to FIG. 1, a particular embodiment of a system 100 includes a data storage device 102 and a host device 150. In the particular example of FIG. 1, the data storage device 102 is coupled to the host device 150. For example, the data storage device 102 may be removably coupled to the host device 150, such as in connection with a removable universal serial bus (USB) configuration. In at least one alternate embodiment, the data storage device 102 is embedded within the host device 150, such as in accordance with an embedded MultiMedia Card (eMMC) configuration.

To further illustrate, the data storage device 102 may correspond to a memory card, such as a Secure Digital SD® card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). As another example, the data storage device 102 may be configured to be coupled to the host device 150 as embedded memory, such as in connection with eMMC® (trademark of JEDEC Solid State Technology Association, Arlington, Va.) and eSD configurations, as illustrative examples. To illustrate, the data storage device 102 may correspond to an eMMC device. The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The data storage device 102 includes a non-volatile memory 104 and a controller 124. The non-volatile memory 104 and the controller 124 may be coupled via a bus, an interface, or other structure. The non-volatile memory 104 may include multiple blocks of storage elements. In the example of FIG. 1, the non-volatile memory 104 includes a block 106 and a block 122. The block 106 and the block 122 may respectively correspond to blocks from which and to which data is to be moved. For example, the block 106 may correspond to a source compaction block from which data is to be moved and the block 122 may correspond to a destination compaction block to which the data is to be moved in connection with a compaction process. Each block of the non-volatile memory 104 may include multiple pages. In the example of FIG. 1, the block 106 includes a page 108 and a page 118. The pages 108, 118 may correspond to pages that store data protected by one or more error correcting code (ECC) techniques (e.g., ECC pages).

The controller 124 is configured to receive data and instructions from the host device 150 and to send data to the host device 150. The controller 124 is further configured to send data and commands to the non-volatile memory 104 and to receive data from the non-volatile memory 104. For example, the controller 124 is configured to send data and a write command to cause the non-volatile memory 104 to store the data to a specified address of the non-volatile memory 104. As another example, the controller 124 is configured to send a read command to read data from a specified address of the non-volatile memory 104.

The controller 124 may include an error correcting code (ECC) engine 126, a random access memory (RAM) 128, a trial logical address generator 140, and a host interface 144. The RAM 128 may include a management table 130 that stores logical-to-physical address mappings 132. In a particular embodiment, the management table 130 corresponds to a group address table (GAT) and the logical-to-physical address mappings 132 map logical groups of data to physical addresses of the non-volatile memory 104. As a particular example, the GAT may map a logical address 116 (of valid data 112 in the block 106) and one or more other logical addresses to a physical address associated with the block 106.

The ECC engine 126 may be configured to receive data from the host device 150 to be stored to the non-volatile memory 104 and to generate a codeword based on the data. For example, the ECC engine 126 may include an encoder configured to encode data using an ECC encoding technique. The ECC engine 126 may include a Reed-Solomon encoder, a Bose-Chaudhuri-Hocquenghem (BCH) encoder, a low-density parity check (LDPC) encoder, a turbo encoder, an encoder configured to encode data according to one or more other ECC techniques, or a combination thereof. The ECC engine 126 may include a decoder configured to decode data read from the non-volatile memory 104 to detect and correct, up to an error correction capability of an ECC technique, bit errors that may be present in the data. Due to error correction limitations of ECC techniques, the ECC engine 126 may be unable to correct certain bit errors in read data, as described further below.

The host device 150 may correspond to a mobile telephone, a music player, a video player, a gaming console, an electronic book reader, a personal digital assistant (PDA), a computer, such as a laptop computer or notebook computer, another electronic device, or a combination thereof. The host device 150 communicates via the host controller 144, which may enable the host device 150 to read data from the non-volatile memory 104 and to write data to the non-volatile memory 104. The host device 150 may operate in compliance with a Joint Electron Devices Engineering Council (JEDEC) industry specification, such as a Universal Flash Storage (UFS) Host Controller Interface specification or an embedded MultiMedia Card (eMMC) specification. The host device 150 may operate in compliance with one or more other specifications, such as a Secure Digital (SD) Host Controller specification as an illustrative example. The host device 150 may communicate with the non-volatile memory 104 in accordance with another suitable communication protocol.

During operation, the controller 124 may attempt to read the valid data 112 from the page 108. In a particular illustrative embodiment, the controller 124 attempts to read the valid data 112 upon initiating a compaction process associated with the non-volatile memory 104. For example, if the controller 124 determines that the page 108 of the block 106 stores the valid data 112 and obsolete data 110, the controller 124 may determine that the valid data 112 should be moved to the block 122 (e.g., “consolidated” with other data associated with a particular file) so that the block 106 can be erased and reused.

To move the valid data 112, the controller 124 may read information (e.g., a header 114) indicating the logical address 116 associated with the valid data 112. For example, the controller 124 may read the header 114 and the ECC engine 126 may decode the header 114 to determine the logical address 116. In response to the ECC engine 126 successfully decoding the header 114 to determine the logical address 116, the controller 124 may move the valid data 112 to the block 122 and may update the management table 130 with a physical address of the block 122 to indicate that the valid data 112 is stored at the block 122. As a particular example, the controller 124 may update the logical-to-physical address mappings 132 to indicate that the logical address 116 is associated with a physical address of the block 122 (instead of a physical address associated with the page 108 of the block 106).

If the ECC engine 126 cannot successfully decode the header 114, then the controller 124 determines a decoding error associated with the page 108, such as an uncorrectable error correcting code (UECC) error. For example, if the controller 124 cannot decode the header 114, then the controller 124 may be unable to determine the logical address 116 associated with the valid data 112. The decoding error may prevent the controller 124 from reliably reading the logical address 116 from the header 114. Without the logical address 116, the controller 124 may be unable to update the logical-to-physical address mappings 132. For example, if the logical-to-physical address mappings 132 are indexed by logical addresses, scanning the physical addresses in the logical-to-physical address mappings 132 to find the entry corresponding to the physical address of the page 108 may be lengthy and computationally difficult. Further, the controller 124 may be unable to move the valid data 112 without updating the logical-to-physical address mappings 132, since this technique could result in inaccurate management information (e.g., an incorrect physical address being associated with the logical address 116). Accordingly, the controller 124 may be unable to move the valid data 112 (or may be unable to move the valid data 112 without performing the lengthy physical address search) and operation (e.g., the compaction process) may temporarily stall.

In response to determining the decoding error, the controller 124 may utilize one or more remedial techniques to determine the logical address 116. The particular remedial techniques performed and the order of application of the remedial techniques may depend on the particular application, as will be appreciated by those of skill in the art. The trial logical address generator 140 may apply the remedial techniques to determine one or more trial logical addresses 142. The controller 124 may access the logical-to-physical address mappings 132 using the one or more trial logical addresses 142 to determine whether any of the one or more trial logical addresses 142 is “correct.” That is, the controller 124 may determine whether the logical-to-physical address mappings 132 map any of the one or more trial logical addresses 142 to the physical address of the page 108. If the logical-to-physical address mappings 132 map any of the trial logical addresses 142 to the physical address of the page 108, then the controller 124 has “found” the logical address 116 (e.g., has correctly “guessed” the logical address 116).

According to a first technique, the controller 124 may access the page 118 to determine a logical address 120. For example, the page 118 may correspond to a “neighbor” page, such as a neighbor ECC page, that is within a certain address range of the page 108 (e.g., within three physical address values of the physical address of the page 108). In a particular embodiment, the page 118 is adjacent to the page 108 (e.g., is within one physical address value of the physical address of the page 108). For example, the pages 108, 118 may correspond to neighboring ECC pages on a single word line of the non-volatile memory 104. As another example, the pages 108, 118 may correspond to neighboring ECC pages on adjacent word lines at sequential physical addresses of the non-volatile memory 104.

According to the first technique, the controller 124 may determine the one or more trial logical addresses 142 based on the logical address 120. For example, the controller 124 may read the page 118 to determine whether the ECC engine 126 can provide an error-corrected version of the logical address 120. If the ECC engine 126 provides the error-corrected version of the logical address 120, the trial logical address generator 140 may increment or decrement the logical address 120 based on a number of physical addresses between the page 108 and the page 118. To illustrate, if the physical address of the page 108 corresponds to x and the physical address of the page 118 corresponds to x+1, then the trial logical address generator 140 may decrement the logical address 120 by one logical address value to determine one of the trial logical addresses 142. As another illustration, if the physical address of the page 108 corresponds to x and the physical address of the page 118 corresponds to x−2, then the trial logical address generator 140 may increment the logical address 120 by two logical address values to determine one of the one or more trial logical addresses 142. The first technique may be particularly effective when the valid data 112 is included in a large file that is stored across multiple pages of the non-volatile memory 104.

Alternatively or in addition to the first technique, the trial logical address generator 140 may use a second technique to determine the one or more trial logical addresses 142. According to the second technique, the trial logical address generator 140 may attempt to use the logical address 116 “as is” despite the decoding error associated with the header 114 and/or the page 108. For example, although the ECC engine 126 may be unable to decode the valid data 112 due to a large number of errors (causing the decoding error associated with the page 108), certain bits of the header 114 may be uncorrupted. Thus, in accordance with the second technique, the trial logical address generator 140 may attempt to use the logical address 116 “as is” (e.g., by accessing the logical-to-physical address mappings 132 using the logical address 116 despite the decoding error).

Alternatively, or in addition to the first technique and/or the second technique, the trial logical address generator 140 may use a third technique to determine the one or more trial logical addresses 142. According to the third technique, the trial logical address generator 140 may toggle at least one bit of the logical address 116 to generate the one or more trial logical addresses 142. For example, the trial logical address generator 140 may iteratively toggle each bit of the logical address 116 and access the logical-to-physical address mappings 132. The third technique may be particularly effective when a single particular bit error is in the logical address 116.

If accessing the logical-to-physical address mappings 132 using any of the one or more trial logical addresses 142 returns a physical address that corresponds to (e.g., “matches”) the physical address of the page 108, then the controller 124 may determine that the correct logical address corresponding to the page 108 has been remedially determined. Accordingly, the controller 124 may continue operation (e.g., the compaction process may continue). For example, the controller 124 may move the valid data 112 to the block 122 and update the logical-to-physical address mappings 132 to indicate that the logical address 116 is associated with the physical address of the block 122. After moving the valid data 112 to the block 122, the controller 124 may erase the block 106 (e.g., to erase the obsolete data 110).

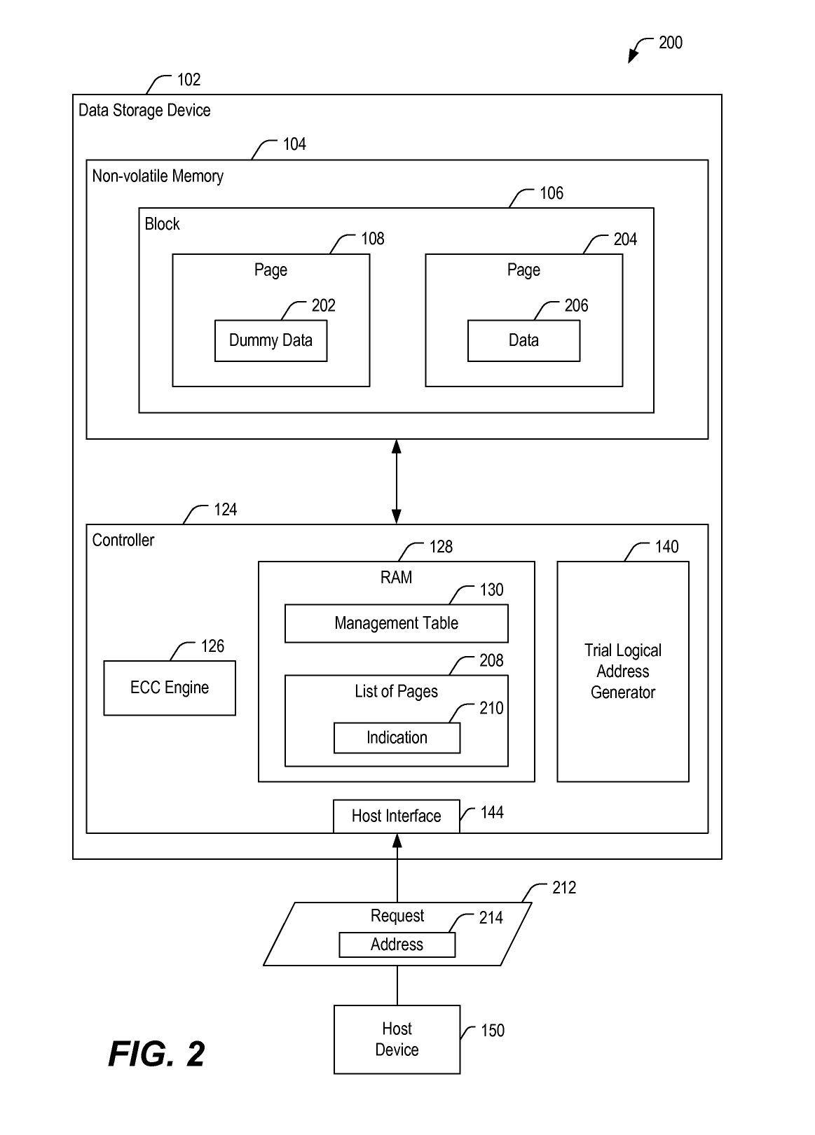

If accessing the logical-to-physical address mappings 132 using the one or more trial logical addresses 142 does not return a physical address that corresponds to (e.g., “matches”) the physical address of the page 108, then the controller 124 may determine that the correct logical address corresponding to the page 108 has not been remedially determined. In at least one embodiment, the controller 124 is configured to add an indication of the physical address of the page 108 to a list of pages associated with decoding errors, as explained further with reference to FIG. 2.

By using one or more of the remedial techniques described with reference to FIG. 1, the controller 124 may remedially determine the logical address 116 when the valid data 112 cannot be decoded. Without such remedial techniques, the controller 124 may be unable to continue the compaction process—for example, if the logical address 116 cannot be determined, then the controller 124 may be unable to update the logical-to-physical address mappings 132 with the physical address of a destination page in the block 122, stalling the compaction process. Using one or more of the remedial techniques of FIG. 1 may thus improve performance of the data storage device 102.

Referring to FIG. 2, a particular illustrative embodiment of a system is depicted and generally designated 200. In a particular embodiment, the system 200 corresponds to a second operational state of the system 100 of FIG. 1.

Certain components and operations of the system 200 of FIG. 2 may be as described with reference to the system 100 of FIG. 1. For example, the system 200 includes the data storage device 102 and the host device 150. The data storage device 102 includes the non-volatile memory 104 and the controller 124. The non-volatile memory 104 includes the block 106. The controller 124 includes the ECC engine 126, the RAM 128, the trial logical address generator 140, and the host interface 144. The block 106 includes the page 108. The RAM 128 stores the management table 130.

In the particular example of FIG. 2, the block 106 further includes a page 204, and the RAM 128 further stores a list 208. The list 208 may indicate addresses (e.g., physical addresses) of pages of the non-volatile memory 104 associated with uncorrected decoding errors, such as uncorrectable error correcting code (UECC) errors.

In operation, the controller 124 may determine that the page 108 is associated with an uncorrected decoding error. For example, if none of the remedial techniques described with reference to FIG. 1 generates a logical address corresponding to the physical address of the page 108, then the controller 124 may determine that the page 108 is associated with an uncorrected decoding error. In a particular illustrative embodiment, the trial logical address generator 140 is configured to successively apply the first technique to generate a first trial logical address of the one or more trial logical addresses 142, the second technique to generate a second trial logical address of the one or more trial logical addresses 142, and the third technique to generate one or more third trial logical addresses (e.g., a sequence of trial addresses generated by “flipping” bits at successive bit positions in the logical address 116) of the one or more trial logical addresses 142. The controller 124 may be configured to access the management table 130 using the first trial logical address, the second trial logical address, and the third trial logical address in succession. If none of the first trial logical address, the second trial logical address, and the one or more third trial logical addresses corresponds to the physical address of the page 108, then the controller 124 may determine that the page 108 is associated with an uncorrected decoding error.

In response to determining that the page 108 is associated with an uncorrected decoding error, the controller 124 may add an indication 210 of the page 108 to the list 208. For example, the indication 210 may specify the physical address associated with the page 108.

The controller 124 may access the list 208 in response to memory access requests from the host device 150. For example, the controller 124 may receive a request 212 from the host device 150. The request 212 may indicate read access corresponding to an address 214 (e.g., a logical address). The controller 124 may determine whether the list 208 includes an indication corresponding to the address 214. For example, the controller 124 may access the list 208 upon performing an address translation operation (e.g., upon translating the address 214 to a physical address using the management table 130). Upon performing the address translation operation to determine the physical address corresponding to the address 214, the controller 124 may access the list 208 to determine whether the list 208 includes an indication of the physical address.

If the list 208 includes an indication of the physical address corresponding to the address 214 (e.g., if the request 212 indicates that the host device 150 is attempting to read data from the page 108), the controller 124 may return a predetermined data sequence to the host device 150. The predetermined data sequence may indicate that the physical address corresponding to the address 214 is associated with an uncorrected decoding error, such as an uncorrectable error correcting code (UECC) error, and that the requested data cannot be provided to the host device 150. In a particular embodiment, the predetermined data sequence includes a sequence of logical bits each having a logical zero value.

In the particular operational state illustrated in FIG. 2, the management table 130 still references the page 108 due to the decoding error associated with the page 108. That is, because the correct logical address associated with the page 108 could not be remedially determined, the management table 130 still indicates that the page 108 stores valid data. Accordingly, new valid data should not be written to the page 108 while the management table 130 still references the page 108, since writing new data to the page 108 could result in the management table 130 mapping multiple logical addresses to the physical address of the page 108, which is undesirable. Instead, the controller 124 may erase the block 106 and then write dummy data 202 to the page 108. The dummy data 202 may include a random or pseudo-random sequence of logical bits to reduce charge coupling or other effects that may result from maintaining an erased page in a block that is otherwise used for data storage.

The dummy data 202 may be written to the page 108 according to a first example or according to a second example. According to the first example, in response to determining that the page 108 is associated with an uncorrected decoding error, the controller 124 may erase contents of the page 108 and write dummy data 202 to the page 108. As new data is written to the block, the page 108 is “skipped.” For example, when data 206 is to be written to the block 106, the data 206 is written to the page 204, “skipping” the page 108.

According to the second example, in response to determining that the page 108 is associated with an uncorrected decoding error, the controller 124 may erase contents of the page 108 and begin writing new data to the block 106. For example, the controller 124 may write the data 206 to the page 204. The controller 124 may write valid data to the block 106 and write the dummy data 202 to the page 108 when the block 106 is otherwise “filled” up to the point of the page 108. The second example may be particularly suitable in configurations in which device operation is improved by writing data to blocks in sequential order (e.g., to avoid hardware problems, such as charge accumulation, due to writing data to blocks non-sequentially).

After the controller 124 writes the dummy data 202 to the page 108 and adds an indication of the block 106 to a list of available blocks (e.g., at the management table 130), the host device 150 may attempt to read or rewrite the erased contents of the page 108 (i.e., the valid data 112 in the particular example of FIG. 1). Because such a request from the host device 150 may indicate a logical address associated with the erased contents (i.e., the logical address 116 in the example of FIG. 1), the data storage device 102 may utilize such a request to “recover” the logical address 116. For example, the controller 124 may update the management table 130 and remove the indication 210 from the list 208 in response to such a request.

As a particular example, the host device 150 may rewrite the valid data 112 of FIG. 1 to the data storage device 102. If the host device 150 rewrites the valid data 112 after erasure of the valid data 112, then the controller 124 may erase contents of the page 108, update the management table 130 with the physical address to which the valid data 112 is to be written, and remove the indication 210 from the list 208.

As another example, the host device 150 may attempt to read the valid data 112 of FIG. 1 (e.g., via the request 212). If the host device 150 attempts to read the valid data 112 after erasure of the valid data 112, the controller 124 may operate as described above in response to receiving the request 212. For example, the controller 124 may return a predetermined data sequence to the host device 150 indicating that the valid data 112 is unavailable and cannot be provided to the host device 150. In addition, the controller 124 may update the management table 130 (e.g., delete a mapping associated with the logical address 116 of FIG. 1) and may remove the indication 210 from the list 208.

Because the controller 124 maintains the list 208, the controller 124 may “delay” updating the management table 130 until a request is received from the host device 150 specifying the logical address 116, which could not be recovered using the remedial techniques of FIG. 1. In particular, the list 208 may be accessed by the controller 124 to ensure that the logical address 116 is not inadvertently mapped to multiple physical addresses in the management table 130, which may cause poor performance (e.g., erasure of valid data).

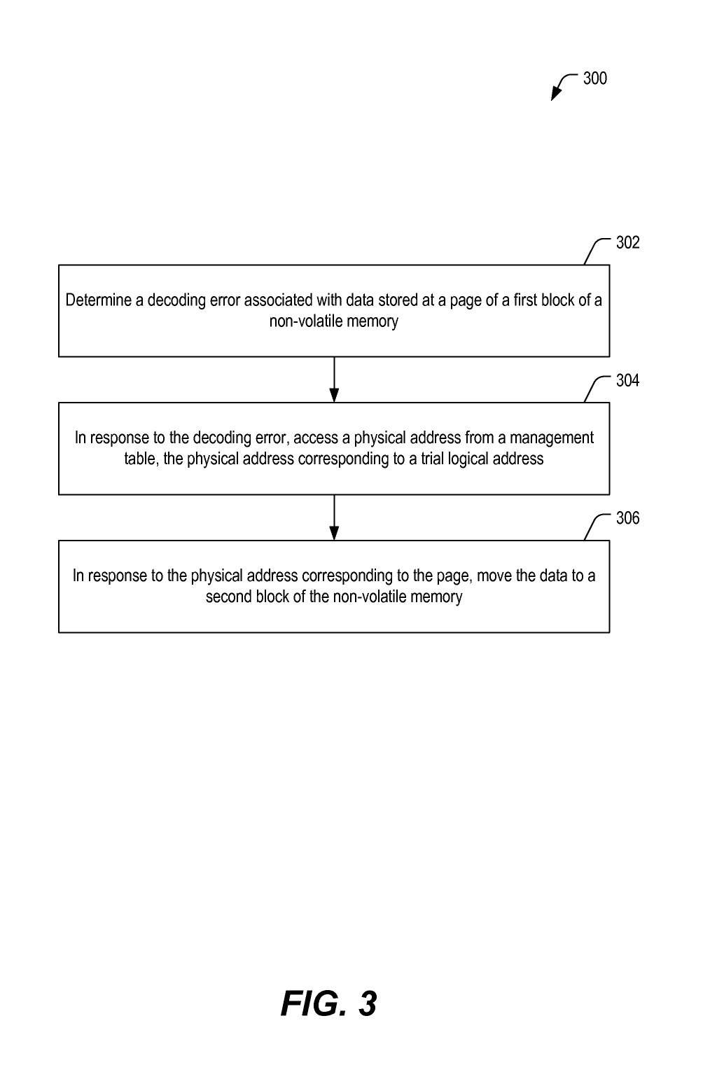

Referring to FIG. 3, a particular illustrative embodiment of a method is depicted and generally designated 300. The method 300 may be performed in the data storage device 102, such as by the controller 124.

At 302, the method 300 includes determining a decoding error associated with data stored at a page of a first block of a non-volatile memory. In a particular illustrative embodiment, the decoding error is determined during a compaction process associated with the non-volatile memory. The decoding error may correspond to an uncorrectable error correcting code (UECC) error. The non-volatile memory may correspond to the non-volatile memory 104. The first block may correspond to the block 106. The data may correspond to the valid data 112.

At 304, the method 300 further includes accessing, in response to the decoding error, a physical address from a management table. The physical address corresponds to a trial logical address, which may correspond to any of the one or more trial logical addresses 142. The management table may correspond to the management table 130. In a particular embodiment, the management table corresponds to a group address table (GAT). The trial logical address may be determined by the trial logical address generator 140.

At 306, the method 300 further includes moving the data to a second block of the non-volatile memory in response to the physical address corresponding to the page. For example, if the physical address accessed from the management table is the physical address of the page, then the physical address accessed from the management table corresponds to (e.g., “matches”) the page. The second block may correspond to the block 122.

By using the trial logical address to access the management table, complex operations may be avoided. For example, “crawling” (e.g., scanning) the management table to find the correct logical address may be avoided. Crawling the management table to determine the correct logical address may be time-consuming, particularly when the management table stores thousands of entries indexed by logical addresses. Accordingly, using the trial logical address simplifies operation and improves performance of the data storage device.

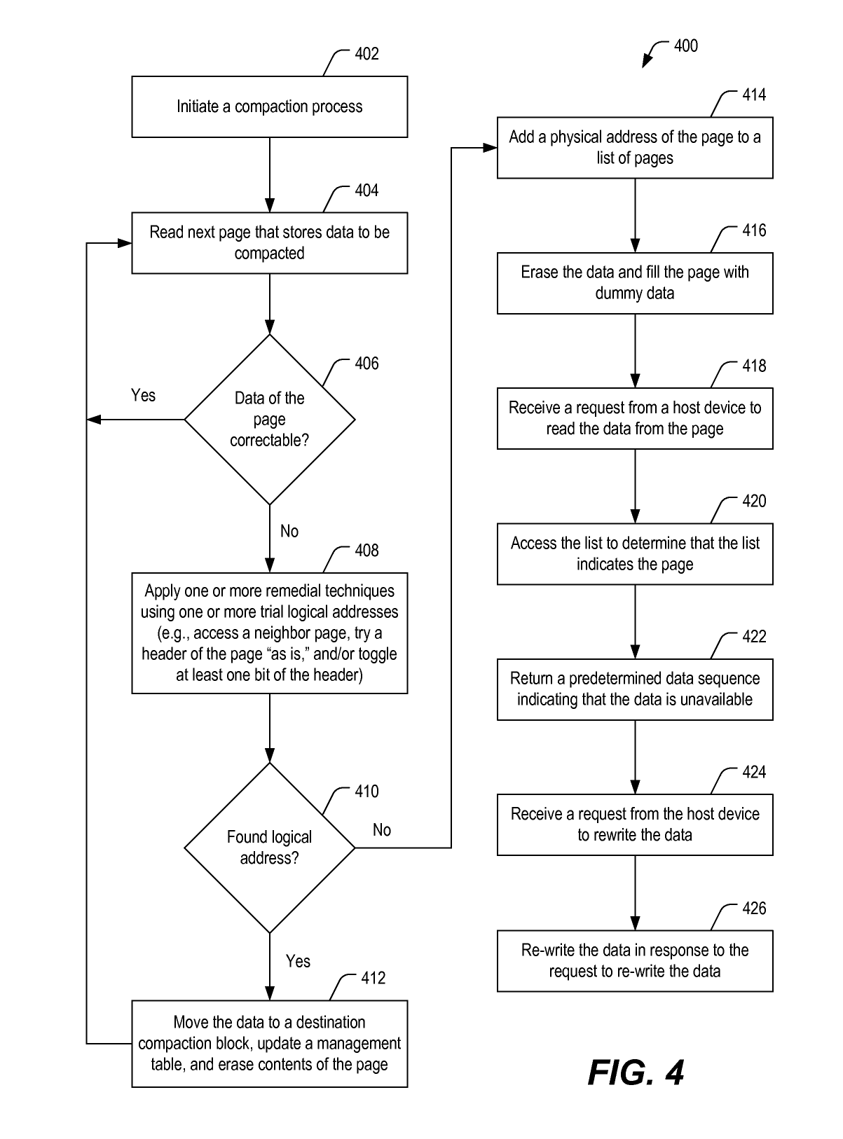

Referring to FIG. 4, a particular illustrative embodiment of a method is depicted and generally designated 400. The method 400 may be performed in the data storage device 102, such as by the controller 124.

The method 400 includes initiating a compaction process, at 402. At 404, a page is read. The page stores data to be compacted. The page may correspond to the page 108. A determination is made whether the data is correctable, at 406. If the data is correctable (e.g., if the ECC engine 126 successfully decodes the data), then a next page is read. If the data is not correctable, such as in response to an uncorrectable error correcting code (UECC) error, one or more remedial techniques are applied using one or more trial logical addresses, at 408. The remedial techniques may include one or more of the first technique, the second technique, and the third technique described with reference to FIG. 1. The one or more trial logical addresses may correspond to the one or more trial logical addresses 142.

A determination is made whether the logical address corresponding to the page has been found, at 410. If the logical address has been found, the method 400 further includes moving the data to a destination compaction block, updating a management table (e.g., the management table 130), and erasing contents of the page, at 412. The destination compaction block may correspond to the block 122.

If the logical address has not been found, then a physical address of the page is added to a list of pages, at 414. For example, the indication 210 may be added to the list 208. At 416, the data is erased and the page is filled with dummy data, such as the dummy data 202. The page may be filled with the dummy data according to the first example or according to the second example, as described with reference to FIG. 2.

At 418, a request is received from a host device, such as the host device 150, to read the data from the page. The request may correspond to the request 212. At 420, the list is accessed to determine that the list indicates the page (e.g., the list indicates the physical address of the page). At 422, a predetermined data sequence is returned to the host device indicating that the data is unavailable (e.g., due to the decoding error). The predetermined data sequence may be returned to the host device in response to accessing the list of pages and further in response to determining that the list of pages indicates that the page is associated with the decoding error. In a particular embodiment, the management table may be updated in response to receiving the request to read the data from the page. For example, if the request to read the data from the page indicates the logical address associated with the page, the logical address may be used to access the management table and update the management table to indicate that the data has been lost (e.g., that the logical address is no longer mapped to the physical address of the page). In response to updating the management table, the indication may be removed from the list.

At 424, a request is received from the host device to rewrite the data. The request may be received in response to the predetermined data sequence. For example, in certain applications, the host device may be able to rewrite the data in response to receiving the predetermined data sequence indicating that the data is unavailable (e.g., when a user subsequently loads the data to the host device, such as in connection with loading or saving a file at the host device). According to further embodiments, the request to rewrite the data may be received prior to receiving a request for read access to the data.

At 426, the data is rewritten in response to the request to re-write the data. In a particular embodiment, in response to the request to rewrite the data, the logical address indicated by the request to rewrite the data is used to update the list and to update the management table. For example, the list may be updated to remove the indication of the page from the list (if the indication has not already been removed, such as in response to a previous request for read access to the page) and the management table may be updated to indicate that the physical address of the page is no longer associated with the logical address (if such an update has not occurred previously, such as in response to a request for read access to the page).

After removing the indication from the list of pages, the source compaction block may be reused without re-writing dummy data to the page. For example, data at each page of the source compaction block (including the dummy data) may be erased. The source compaction block may be maintained in an erase state or may be populated with host data (e.g., in response to a request for write access from the host device) in a conventional manner that stores host data to the page.

By operating in accordance with the method 400 of FIG. 4, decoding errors may be handled using trial logical addresses. Further, handling of such decoding errors may be delayed (e.g., while the compaction process continues) by maintaining a list of pages associated with decoding errors (e.g., uncorrected decoding errors). Accordingly, maintaining the list of pages may avoid uncorrectable data being accessed in response to host requests.

The techniques described herein may be particularly advantageous for data storage device configurations in which host devices can write data to any particular block at a given time (e.g., configurations where data can be written non-sequentially). For example, in configurations where data can be written non-sequentially, pages of a particular block may not be associated with related data. The second remedial technique and the third remedial technique described with reference to FIG. 1 may be advantageous in such configurations. The first technique remedial described with reference to FIG. 1 may be advantageous in configurations where data is written sequentially. The technique or techniques utilized may be selected based on the particular application. Further, the techniques described herein may be implemented by data storage devices “transparently” to host devices (e.g., without altering configuration or operation of host devices).

Although various components depicted herein are illustrated as block components and described in general terms, such components may include one or more microprocessors, state machines, or other circuits configured to enable the controller 124 (or one or more components thereof) to perform operations described herein. For example, the trial logical address generator 140 may correspond to one or more physical components, such as hardware controllers, state machines, logic circuits, one or more other structures, or a combination thereof, to enable the controller 124 to perform one or more operations described herein.

To further illustrate, according to a particular example, a processing unit of the controller 124 of FIG. 1 may execute general purpose instructions (e.g., instructions associated with a general purpose instruction set architecture) to store a management table, such as the management table 130. The management table may be stored and maintained by executing general purpose instructions, such as by executing general purpose read and write instructions. The processing unit may determine a decoding error associated with information stored in a page of a first block of the non-volatile memory, such as the page 108 of the block 106. As a particular example, a parity error may be determined by executing general purpose add and compare instructions. In response to the decoding error, the processing unit may access a physical address from the management table (e.g., by executing a general purpose read instruction). The physical address corresponds to a trial logical address, such as the one or more trial logical addresses 142. In response to the physical address corresponding to the page, the processing unit may move data from the page to a second block, such as the block 122 (e.g., by executing general purpose move or write instructions).

One or more aspects of the controller 124 may be implemented using a microprocessor or microcontroller programmed to perform operations described herein, such as operations corresponding to the methods 300 and 400 of FIGS. 3 and 4. In a particular embodiment, the controller 124 includes a processor executing instructions that are stored at the non-volatile memory 104. Alternatively or in addition, executable instructions that are executed by the processor may be stored at a separate memory location that is not part of the non-volatile memory 104, such as at a read-only memory (ROM).

In a particular embodiment, the data storage device 102 may be implemented in a portable device configured to be selectively coupled to one or more external devices, such as the host device 150. However, in other embodiments, the data storage device 102 may be attached to or embedded within one or more host devices, such as within a housing of a host communication device, which may correspond to the host device 150. For example, the data storage device 102 may be integrated within a packaged apparatus such as a wireless telephone, a personal digital assistant (PDA), a gaming device or console, a portable navigation device, or other device that uses internal non-volatile memory. In a particular embodiment, the data storage device 102 may be coupled to a non-volatile memory, such as a three-dimensional (3D) memory, a flash memory (e.g., NAND, NOR, multi-level cell (MLC)), a divided bit-line NOR (DINOR) memory, an AND memory, a high capacitive coupling ratio (HiCR) device, an asymmetrical contactless transistor (ACT) device, or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. As a particular example, although certain ECC error handling techniques have been described herein with reference to an example compaction process, such techniques may be applied to other device operations and configurations, such as other operations that include moving data from one page to another page of a non-volatile memory. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
in a data storage device including a non-volatile memory and a controller, wherein the controller stores a management table, performing by the controller:
determining a decoding error associated with information stored at a page of a first block of the non-volatile memory;
in response to the decoding error, accessing a physical address from the management table, the physical address corresponding to a trial logical address; and
in response to the physical address corresponding to the page, moving data from the page to a second block of the non-volatile memory.

2. The method of claim 1, wherein the decoding error is determined during a compaction process associated with the non-volatile memory, wherein the first block corresponds to a source compaction block, and wherein the second block corresponds to a destination compaction block.

3. The method of claim 2, wherein the decoding error prevents reliable reading of a logical address from a header associated with the data.

4. The method of claim 1, further comprising updating the management table with a second physical address, the second physical address associated with the second block.

5. The method of claim 1, further comprising determining the trial logical address, wherein determining the trial logical address comprises:
reading a logical address stored at a second page that neighbors the page; and
generating the trial logical address based on the logical address stored at the second page.

6. The method of claim 1, further comprising determining the trial logical address, wherein determining the trial logical address comprises reading a logical address from a header associated with the page.

7. The method of claim 1, further comprising determining the trial logical address, wherein determining the trial logical address includes toggling at least one bit of a logical address read from a header associated with the page.

8. A data storage device comprising:
a non-volatile memory; and
a controller coupled to the non-volatile memory, the controller configured to store a management table, wherein the controller is further configured to:
determine a decoding error associated with information stored at a page of a first block of the non-volatile memory;
in response to the decoding error, access a physical address from the management table, the physical address corresponding to a trial logical address; and
in response to the physical address corresponding to the page, move data from the page to a second block of the non-volatile memory.

9. The data storage device of claim 8, wherein the data storage device is embedded within a host device.

10. The data storage device of claim 8, wherein the controller is further configured to determine the trial logical address by reading a logical address of a second page that neighbors the page and by generating the trial logical address based on the logical address.

11. The data storage device of claim 10, wherein the controller is further configured to determine, in response to the physical address not corresponding to the page, a second trial logical address by reading a logical address from a header associated with the page.

12. The data storage device of claim 11, wherein the controller is further configured to access a second physical address from the management table, the second physical address corresponding to the second trial logical address.

13. The data storage device of claim 12, wherein the controller is further configured to determine, in response to the second physical address not corresponding to the page, a third trial logical address by toggling at least one bit of the logical address read from the header.

14. The data storage device of claim 13, wherein the controller is further configured to access a third physical address from the management table, the third physical address corresponding to the third trial logical address.

15. The data storage device of claim 8, wherein the controller is further configured to maintain a list of pages of the non-volatile memory that are associated with uncorrected decoding errors.

16. The data storage device of claim 15, wherein the controller is further configured to access, in response to receiving from a host device a request corresponding to a particular physical address, the list of pages and to check for the particular physical address in the list.

17. The data storage device of claim 16, wherein the controller is further configured to return a predetermined data sequence to the host device in response to the list indicating the particular physical address, the predetermined data sequence indicating that the data is unavailable.

18. The data storage device of claim 15, wherein the controller is further configured to write dummy data to the page in response to the physical address not corresponding to the page.

19. The data storage device of claim 15, wherein the controller is further configured to receive from a host device a request to rewrite the data and to remove the indication from the list of pages in response to the request.

20. The data storage device of claim 8, wherein the controller includes a random access memory (RAM) configured to store the management table, and wherein the controller further includes an error correcting code (ECC) engine configured to determine the decoding error.
